(19) United States
(12) Patent Application Publication
(10) Pub. No.: US 2020/0065595 A1
(43) Pub. Date: Feb. 27, 2020

(54) DRIVER STATE ESTIMATION DEVICE AND DRIVER STATE ESTIMATION METHOD

(71) Applicant: OMRON Corporation, Kyoto-shi, KYOTO (JP)

(72) Inventors: Tadashi HYUGA, Hirakata-shi (JP); Masaki SUWA, Kyoto-shi (JP)

(73) Assignee: OMRON Corporation, Kyoto-shi, KYOTO (JP)

(21) Appl. No.: 16/481,846

(22) PCT Filed: Jul. 27, 2017
(86) PCT No.: PCT/JP2017/027245

§ 371 Date: Jul. 30, 2019

(30) Foreign Application Priority Data
Mar. 14, 2017 (JP) 2017-048503

(51) Int. Cl. G06K 9/00; G06T 7/571

(52) U.S. Cl. CPC G06K 9/00845; G06T 7/571; B60W 40/08; G06T 2207/30268; G06T 2207/30196

(57) ABSTRACT

A driver state estimation device which can estimate a distance to a head position of a driver without detecting a center position of a face area of the driver in an image, comprises a monocular camera 11 which can pick up an image of a driver sitting in a driver's seat, a storage section 15 and a CPU 12, the storage section 15 comprising an image storing part 15a for storing the image picked up by the monocular camera 11, and the CPU 12 comprising a head detecting section 23 for detecting a head of the driver in the image read from the image storing part 15a, a defocus amount detecting section 24 for detecting a defocus amount of the head of the driver in the image detected by the head detecting section 23 and a distance estimating section 25 for estimating a distance from the head of the driver sitting in the driver's seat to the monocular camera 11 with use of the defocus amount detected by the defocus amount detecting section 24.

### TECHNICAL FIELD

The present invention relates to a driver state estimation device and a driver state estimation method, and more particularly, to a driver state estimation device and a driver state estimation method, whereby a state of a driver can be estimated using picked-up images.

### BACKGROUND ART

Techniques of detecting a state of a driver's motion or line of sight using images of the driver taken by an in-vehicle camera so as to present information required by the driver or give an alarm have been developed through the years.

In an automatic vehicle operation system the development of which has been recently promoted, it is considered that a technique of continuously estimating whether a driver is in a state of being able to conduct a driving operation comes to be necessary even during an automatic vehicle operation, for smooth switching from the automatic vehicle operation to a manual vehicle operation. The development of techniques of analyzing images picked up by an in-vehicle camera to estimate a state of a driver is proceeding.

In order to estimate the state of the driver, techniques of detecting a head position of the driver are required. For example, in Patent Document 1, a technique wherein a face area of a driver in an image picked up by an in-vehicle camera is detected, and on the basis of the detected face area, a head position of the driver is estimated, is disclosed.

In the above method for estimating the head position of the driver, specifically, an angle of the head position with respect to the in-vehicle camera is detected. As a method for detecting said angle of the head position, a center position of the face area on the image is detected. Regarding said detected center position of the face area as the head position, a head position line which passes through said center position of the face area is obtained, and an angle of said head position line (the angle of the head position with respect to the in-vehicle camera) is determined.

Thereafter, a head position on the head position line is detected. As a method for detecting said head position on the head position line, a standard size of the face area in the case of being a prescribed distance away from the in-vehicle camera is previously stored. By comparing this standard size to the size of the actually detected face area, a distance from the in-vehicle camera to the head position is obtained. A position on the head position line away from the in-vehicle camera by the obtained distance is estimated to be the head position.

### Problems to be Solved by the Invention

In the method for estimating the head position described in Patent Document 1, the head position on the image is detected with reference to the center position of the face area. However, the center position of the face area varies according to a face direction. Therefore, even in cases where the head position is at the same position, with different face directions, the center position of the face area detected on each image is detected at a different position. As a result, the head position on the image is detected at a position different from the head position in the real world, that is, the distance to the head position in the real world cannot be accurately estimated.

### PRIOR ART DOCUMENT

### Patent Document

Patent Document 1: Japanese Patent Application Laid-Open Publication No. 2014-218140

### Non-Patent Document

Non-Patent Document 1: Yalin Xiong, Steven A. Shafer, “Depth from Focusing and Defocusing”, CMU-RI-TR-93-07, The Robotics Institute Carnegie Mellon University Pittsburgh, Pa. 15213, March, 1993.

Non-Patent Document 2: D. B. Gennery, “Determination of optical transfer function by inspection of frequency-domain plot”, Journal of the Optical Society of America, vol. 63, pp. 1571-1577, 1973.

Non-Patent Document 3: Morihiko SAKANO, Noriaki SUETAKE, Eiji UCHINO, “A noise-robust estimation for out-of-focus PSF by using a distribution of gradient vectors on the logarithmic amplitude spectrum”, The IEICE Transactions on Information and Systems, Vol. J90-D, No. 10, pp. 2848-2857.

Non-Patent Document 4: A. P. Pentland, “A new sense for depth of field”, IEEE Transaction on Pattern Analysis and Machine Intelligence, 9, 4, pp. 523-531 (1987).

Non-Patent Document 5: S. Zhou, T. Sim, “Defocus Map Estimation from a Single Image”, Pattern Recognition, Vol. 44, No. 9, pp. 1852-1858, (2011).

Non-Patent Document 6: YOAV Y. SCHECHNER, NAHUM KIRYATI, “Depth from Defocus vs. Stereo: How Different Really Are They?” International Journal of Computer Vision 39(2), 141-162, (2000).

### SUMMARY OF THE INVENTION

### Means for Solving Problem and the Effect

The present invention was developed in order to solve the above problems, and it is an object of the present invention to provide a driver state estimation device and a driver state estimation method, whereby a distance to a head of a driver can be estimated without detecting a center position of a face area of the driver in an image, and said estimated distance can be used for deciding a state of the driver.

In order to achieve the above object, a driver state estimation device according to a first aspect of the present invention is characterized by estimating a state of a driver using a picked-up image, said driver state estimation device comprising:

an imaging section which can pick up an image of a driver sitting in a driver's seat; and

at least one hardware processor,

said at least one hardware processor comprising

a head detecting section for detecting a head of the driver in the image picked up by the imaging section,

a defocus amount detecting section for detecting a defocus amount of the head of the driver in the image detected by the head detecting section, and

a distance estimating section for estimating a distance from the head of the driver sitting in the driver's seat to the imaging section with use of the defocus amount detected by the defocus amount detecting section.

Using the driver state estimation device according to the first aspect of the present invention, the head of the driver in the image is detected using the image of the driver picked up by the imaging section, the defocus amount of the detected head of the driver in the image is detected, and the distance from the head of the driver sitting in the driver's seat to the imaging section is estimated with use of the defocus amount. Accordingly, without obtaining a center position of the face area in the image, the distance can be estimated based on the defocus amount of the head of the driver in the image. Using said estimated distance, it becomes possible to estimate a state such as a position and attitude of the driver sitting in the driver's seat.

The driver state estimation device according to a second aspect of the present invention is characterized by comprising a table information storing part for storing table information showing a correlation between the distance from the head of the driver sitting in the driver's seat to the imaging section and the defocus amount of the image of the driver to be picked up by the imaging section, wherein

the distance estimating section compares the defocus amount detected by the defocus amount detecting section with the table information read from the table information storing part to estimate the distance from the head of the driver sitting in the driver's seat to the imaging section in the driver state estimation device according to the first aspect of the present invention.

Using the driver state estimation device according to the second aspect of the present invention, the table information showing the correspondence of the defocus amount of the image of the driver to be picked up by the imaging section and the distance from the head of the driver to the imaging section is stored in the table information storing part, and the defocus amount detected by the defocus amount detecting section is compared with the table information read from the table information storing part to estimate the distance from the head of the driver sitting in the driver's seat to the imaging section. Accordingly, by fitting the defocus amount to the table information, the distance from the head of the driver sitting in the driver's seat to the imaging section can be speedily estimated without applying a load to operations.

The driver state estimation device according to a third aspect of the present invention is characterized by the distance estimating section which estimates the distance from the head of the driver sitting in the driver's seat to the imaging section in consideration of changes in size of the face area of the driver detected in a plurality of images picked up by the imaging section in the driver state estimation device according to the first or second aspect of the present invention.

Using the driver state estimation device according to the third aspect of the present invention, by taking into consideration the changes in size of the face area of the driver, it is possible to decide in which direction, forward or backward, the driver is away from a focal position where the imaging section focuses, leading to an enhanced estimation accuracy of the distance.

The driver state estimation device according to a fourth aspect of the present invention is characterized by the at least one hardware processor,

comprising a driving operation possibility deciding section for deciding whether the driver sitting in the driver's seat is in a state of being able to conduct a driving operation with use of the distance estimated by the distance estimating section in the driver state estimation device according to any one of the first to third aspects of the present invention.

Using the driver state estimation device according to the fourth aspect of the present invention, with use of the distance estimated by the distance estimating section, whether the driver sitting in the driver's seat is in the state of being able to conduct a driving operation can be decided, leading to appropriate monitoring of the driver.

The driver state estimation device according to a fifth aspect of the present invention is characterized by the imaging section, which can pick up images of different blur conditions of the head of the driver in accordance with changes in position and attitude of the driver sitting in the driver's seat in the driver state estimation device according to any one of the first to fourth aspects of the present invention.

Using the driver state estimation device according to the fifth aspect of the present invention, even in the limited space of the driver's seat, images of different blur conditions of the head of the driver can be picked up, and therefore, the distance can be certainly estimated based on the defocus amount.

A driver state estimation method according to the present invention is characterized by using a device comprising an imaging section which can pick up an image of a driver sitting in a driver's seat, and at least one hardware processor,

estimating a state of the driver sitting in the driver's seat,

the at least one hardware processor conducting the steps comprising:

detecting a head of the driver in the image picked up by the imaging section;

detecting a defocus amount of the head of the driver in the image detected in the step of detecting the head; and

estimating a distance from the head of the driver sitting in the driver's seat to the imaging section with use of the defocus amount detected in the step of detecting the defocus amount.

Using the above driver state estimation method, with use of the image of the driver picked up by the imaging section, the head of the driver in the image is detected, the defocus amount of the detected head of the driver in the image is detected, and with use of the defocus amount, the distance from the head of the driver sitting in the driver's seat to the imaging section is estimated. Accordingly, without obtaining a center position of the face area in the image, the distance can be estimated based on the defocus amount of the head of the driver in the image. Using the estimated distance, it becomes possible to estimate a state such as a position and attitude of the driver sitting in the driver's seat.

### BRIEF DESCRIPTION OF DRAWINGS

FIG. 1 is a block diagram schematically showing the principal part of an automatic vehicle operation system including a driver state estimation device according to an embodiment of the present invention;

FIG. 2 is a block diagram showing a construction of the driver state estimation device according to the embodiment;

FIG. 3 consists of illustrations for explaining the relationship between a seat position of a driver's seat and a blur condition of a driver in a picked-up image;

FIG. 4 is a diagram for explaining the relationship between a defocus amount to be detected by the driver state estimation device according to the embodiment and a distance to the driver;

FIG. 5 is a graph showing an example of table information showing a correlation between the distance to the driver and the magnitude of the defocus amount; and

FIG. 6 is a flowchart showing processing operations conducted by a CPU in the driver state estimation device according to the embodiment.

### MODE FOR CARRYING OUT THE INVENTION

The embodiments of the driver state estimation device and the driver state estimation method according to the present invention are described below by reference to the Figures. The below-described embodiments are preferred embodiments of the present invention, and various technical limitations are included. However, the scope of the present invention is not limited to these modes, as far as there is no description particularly limiting the present invention in the following explanations.

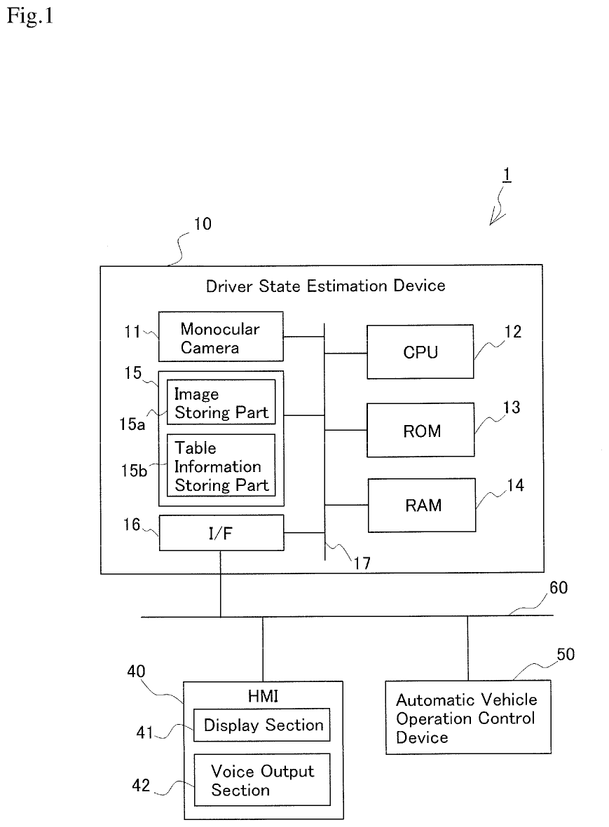

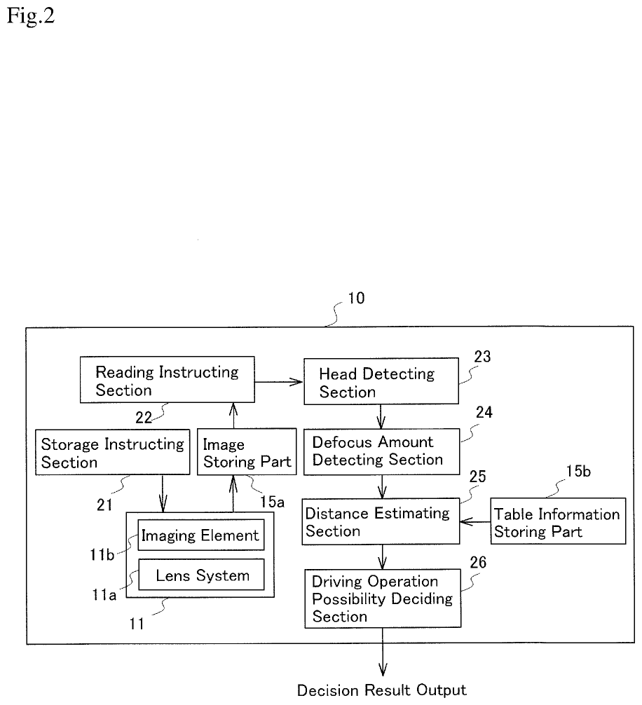

FIG. 1 is a block diagram schematically showing the principal part of an automatic vehicle operation system including a driver state estimation device according to an embodiment. FIG. 2 is a block diagram showing a construction of the driver state estimation device according to the embodiment.

An automatic vehicle operation system 1 is a system for allowing a vehicle to automatically cruise along a road, comprising a driver state estimation device 10, an HMI (Human Machine Interface) 40, and an automatic vehicle operation control device 50, each of which is connected through a communication bus 60. To the communication bus 60, various kinds of sensors and control devices (not shown) required for controlling an automatic vehicle operation and a manual vehicle operation by a driver are also connected.

The driver state estimation device 10 conducts processing of detecting a state of a driver using a picked-up image, specifically, a defocus amount of a head of the driver in the picked-up image so as to estimate a distance from a monocular camera 11 to the head (face) of the driver with use of the defocus amount, processing of deciding whether the driver is in a state of being able to conduct a driving operation based on the estimation result of distance so as to output the decision result, and the like.

The driver state estimation device 10 comprises the monocular camera 11, a CPU 12, a ROM 13, a RAM 14, a storage section 15, and an input/output interface (I/F) 16, each of which is connected through a communication bus 17. Here, the monocular camera 11 may be constructed as a camera unit separately from the device body.

The monocular camera 11 as an imaging section can periodically (e.g. 30-60 times/sec) pick up images including the head of the driver sitting in the driver's seat, and comprises a lens system 11a consisting of one or more lenses, an imaging element 11b such as a CCD or a CMOS which generates imaging data of a subject, an analog-to-digital conversion section (not shown) which converts the imaging data to digital data, an infrared irradiation unit (not shown) such as a near infrared LED which irradiates near infrared light, and associated parts.

What is used as the lens system 11a of the monocular camera 11, has optical parameters such as a focal distance and an aperture (an f-number) of the lens set in such a manner that the driver is brought into focus in any position within the range of adjustment of the driver's seat and that the depth of field becomes shallow (the in-focus range is small). Setting of these optical parameters makes it possible to pick up images of different blur conditions of the head of the driver according to changes in position and attitude of the driver sitting in the driver's seat, for example, changes in the seat position of the driver's seat or the inclination of the backrest (images of different blur conditions from an image focused on the driver to gradually defocused images). The depth of field is preferably set to be as shallow as possible within permissible limits of defocus of processing performance in a below-described head detecting section 23, in order not to hinder the processing performance of the head detecting section 23, that is, the performance of detecting the head and face organs of the driver in the image.

The CPU 12 is a hardware processor, which reads out a program stored in the ROM 13, and based on said program, performs various kinds of processing on image data picked up by the monocular camera 11. A plurality of CPUs 12 may be mounted for every processing such as image processing or control signal output processing.

In the ROM 13, programs for allowing the CPU 12 to perform processing as a storage instructing section 21, a reading instructing section 22, the head detecting section 23, a defocus amount detecting section 24, a distance estimating section 25, and a driving operation possibility deciding section 26 shown in FIG. 2, and the like are stored. All or part of the programs performed by the CPU 12 may be stored in the storage section 15 or a storing medium (not shown) other than the ROM 13.

In the RAM 14, data required for various kinds of processing performed by the CPU 12, programs read from the ROM 13, and the like are temporarily stored.

The storage section 15 comprises an image storing part 15a for storing image data picked up by the monocular camera 11, and a table information storing part 15b for storing table information showing a correlation between a distance from the monocular camera 11 to a subject (driver) and a defocus amount of an image of the subject to be picked up by the monocular camera 11. In the storage section 15, parameter information including a focal distance, an aperture (an f-number), an angle of view and the number of pixels (width×length) of the monocular camera 11, and mounting position information of the monocular camera 11 are also stored. As to the mounting position information of the monocular camera 11, for example, a setting menu of the monocular camera 11 may be constructed in a manner that can be read by the HMI 40, so that when mounting the monocular camera 11, the setting thereof can be selected in the setting menu. The storage section 15 comprises, for example, one or more non-volatile semiconductor memories such as an EEPROM or a flash memory. The input/output interface (I/F) 16 is used for exchanging data with various kinds of external units through the communication bus 60.

Based on signals sent from the driver state estimation device 10, the HMI 40 performs processing of informing the driver of the state thereof such as a driving attitude, processing of informing the driver of an operational situation of the automatic vehicle operation system 1 or release information of the automatic vehicle operation, processing of outputting an operation signal related to automatic vehicle operation control to the automatic vehicle operation control device 50, and the like. The HMI 40 comprises, for example, a display section 41 mounted at a position easy to be viewed by the driver, a voice output section 42, and an operating section and a voice input section, neither of them shown.

The automatic vehicle operation control device 50 is also connected to a power source control unit, a steering control unit, a braking control unit, a periphery monitoring sensor, a navigation system, a communication unit for communicating with the outside, and the like, none of them shown. Based on information acquired from each of these units, control signals for conducting the automatic vehicle operation are output to each control unit so as to conduct automatic cruise control (such as automatic steering control and automatic speed regulation control) of the vehicle.

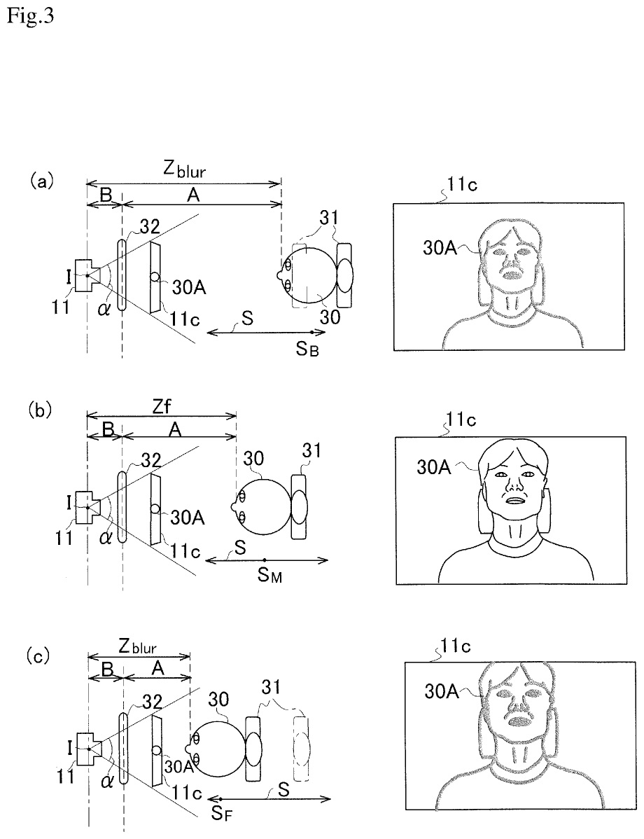

Before explaining each section of the driver state estimation device 10 shown in FIG. 2, the relationship between the seat position of the driver's seat and the blur condition of the driver in the image to be picked up by the monocular camera 11 is described below by reference to FIG. 3. FIG. 3 consists of illustrations for explaining that the blur condition of the driver in the image varies according to different seat positions of the driver's seat.

As shown in FIG. 3, it is a situation in which a driver 30 is sitting in a driver's seat 31. A steering wheel 32 is located in front of the driver's seat 31. The position of the driver's seat 31 can be rearwardly and forwardly adjusted, and the adjustable range of the seat is set to be S. The monocular camera 11 is mounted behind the steering wheel 32 (on a steering column, or at the front of a dashboard or an instrument panel, none of them shown), that is, on a place where images 11c including a head (face) of the driver 30A can be picked up thereby. The mounting position posture of the monocular camera 11 is not limited to this embodiment.

In FIG. 3, a distance from the monocular camera 11 to the driver 30 in the real world is represented by Z (Zf, Z_{blur}), a distance from the steering wheel 32 to the driver 30 is represented by A, a distance from the steering wheel 32 to the monocular camera 11 is represented by B, an angle of view of the monocular camera 11 is represented by α, and a center of an imaging plane is represented by I.

FIG. 3(b) shows a situation wherein the driver's seat 31 is set in an approximately middle position S_{M} within the adjustable range S. In this situation, the position of the head (face on the front of the head) of the driver 30 is a focal position (distance Zf) where the monocular camera 11 focuses, and therefore, in the image 11c, the driver 30A is photographed in focus without blur.

FIG. 3(a) shows a situation wherein the driver's seat 31 is set in a backward position SB within the adjustable range S. Since the position of the head of the driver 30 is farther than the focal position (distance Zf) where the monocular camera 11 focuses (an out-of-focus position) (distance Z_{blur}), in the image 11c, the driver 30A is photographed with a little smaller size than in the middle position S_{M} and with a blur.

FIG. 3(c) shows a situation wherein the driver's seat 31 is set in a forward position S_{F} within the adjustable range S. Since the position of the head of the driver 30 is closer than the focal position (distance Zf) where the monocular camera 11 focuses (an out-of-focus position) (distance Z_{blur}), in the image 11c, the driver 30A is photographed with a little larger size than in the middle position S_{M} and with a blur.

Thus, the monocular camera 11 is set to be focused on the head of the driver 30 in the situation wherein the driver's seat 31 is set in the approximately middle position S_{M}, while in the situation wherein the driver's seat 31 is set in the forward or backward position from the approximately middle position S_{M}, it is set not to be focused on the head of the driver 30 so as to generate a blur on the head of the driver 30A in the image according to the amount of deviation from the focal position.

Here, in this embodiment, the optical parameters of the monocular camera 11 are selected in such a manner that the head of the driver 30 when the driver's seat 31 is set in the approximately middle position S_{M} comes into focus, but the position where the monocular camera 11 focuses is not limited to this position. The optical parameters of the monocular camera 11 may be selected in such a manner that the head of the driver 30 when the driver's seat 31 is set in any position within the adjustable range S comes into focus.

A specific construction of the driver state estimation device 10 according to the embodiment is described below by reference to the block diagram shown in FIG. 2.

The driver state estimation device 10 is established as a device wherein various kinds of programs stored in the ROM 13 are read into the RAM 14 and conducted by the CPU 12, so as to perform processing as the storage instructing section 21, reading instructing section 22, head detecting section 23, defocus amount detecting section 24, distance estimating section 25, and driving operation possibility deciding section 26.

The storage instructing section 21 allows the image storing part 15a which is a part of the storage section 15 to store the image data including the head (face) of the driver 30A picked up by the monocular camera 11. The reading instructing section 22 reads the image 11c in which the driver 30A is imaged from the image storing part 15a.

The head detecting section 23 detects the head (face) of the driver 30A in the image 11c read from the image storing part 15a. The method for detecting the head (face) in the image 11c is not particularly limited. For example, the head (face) may be detected by template matching using a standard template corresponding to the outline of the head (whole face), or template matching based on the components (such as eyes, a nose and ears) of the head (face). Or as a method for detecting the head (face) at a high speed and with high precision, for example, by regarding a contrast difference (a luminance difference) or edge intensity of local regions of the face, for example, the face organs such as the ends of eyes, the ends of a mouth and the edges of nostrils, and the relevance (the cooccurrence) between these local regions as feature quantities so as to learn by combining these feature quantities large in number, a detector is prepared. And the method using such detector having a hierarchical structure (a hierarchical structure from a hierarchy in which the face is roughly captured to a hierarchy in which the minute portions of the face are captured) makes it possible to detect the area of the face at a high speed. In order to deal with differences in the blur condition of the face, the face direction or inclination, a plurality of detectors which are allowed to learn separately according to the blur condition of the face, the face direction or inclination may be mounted.

The defocus amount detecting section 24 detects the defocus amount of the head of the driver 30A in the image 11c detected by the head detecting section 23. As a method for detecting the defocus amount of the driver 30A (a subject) in an image, a publicly known method may be adopted.

For example, a method for obtaining a defocus amount by analyzing picked-up images (see Non-Patent Document 1), a method for estimating a PSF (Point Spread Function) representing the characteristics of blurs based on the radius of a dark ring which appears on the logarithmic amplitude spectrum of an image (see Non-Patent Document 2), a method for expressing the characteristics of blurs using a distribution of luminance gradient vectors on the logarithmic amplitude spectrum of an image to estimate a PSF (see Non-Patent Document 3), and the like may be adopted.

As methods for measuring a distance to a subject by processing a picked-up image, the DFD (Depth from Defocus) method and the DFF (Depth from Focus) method, in which attention is given to the blur of the image according to the focusing position, have been known. In the DFD method, a plurality of images each having a different focal position are photographed, the defocus amounts thereof are fitted to a model function of optical blurs, and a position in which the subject most preferably comes into focus is estimated based on changes in the defocus amount so as to obtain the distance to the subject. In the DFF method, in a line of images large in number photographed with displacing the focal position, the distance from the best in-focus image position is obtained. It is also possible to estimate a defocus amount using these methods.

For example, if the blurs in images comply with a thin lens model, the defocus amounts can be modeled as the above Point Spread Function (PSF). Generally, as this model, the Gaussian function is used. By using these, a method for estimating a defocus amount by analyzing the edges of one or two picked-up images including a blur (Non-Patent Document 4), a method for estimating a defocus amount by analyzing how the edge is deformed (a degree of change of the edge intensity) in a picked-up image including a blur (an input image) and a smoothed image obtained by defocusing said input image again (Non-Patent Document 5), and the like may be adopted. In Non-Patent Document 6, it is disclosed that it is possible to measure a distance to an object by the DFD method, with a similar mechanism to the stereo method, and how the radius of a circle of blur when an image of the object is thrown onto an imaging element plane is obtained. In these methods such as the DFD method, the distance is found from correlation information between the defocus amount of the image and the subject distance, and therefore, they can be implemented using the monocular camera 11. Using these methods, the defocus amount of the image can be detected.

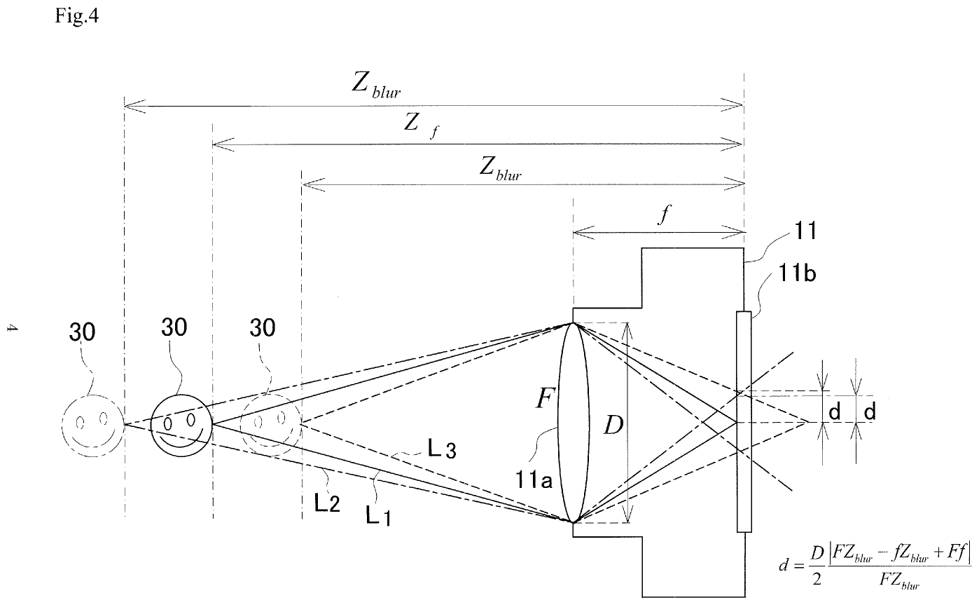

FIG. 4 is a diagram for explaining the relationship between the defocus amount d to be detected by the defocus amount detecting section 24 and a distance to the driver 30 (the mechanism of the DFD method or DFF method).

In FIG. 4, f represents a distance between the lens system 11a and the imaging element 11b, Zf represents a distance between the focal point (focus point) to be in focus and the imaging element 11b, Z_{blur} represents a distance between the driver 30 (a subject) with a blur (defocused) and the imaging element 11b, F represents a focal distance of the lens, D represents an aperture of the lens system 11a, d represents a radius of a circle of blur (a circle of confusion) when the image of the subject is thrown onto the imaging element, being equivalent to a defocus amount.

The defocus amount d can be expressed by the following equation.

$$d = \frac{D}{2} \frac{\vert {FZ}_{blur} - {fZ}_{blur} + Ff \vert}{{FZ}_{blur}} \qquad [ Equation 1 ]$$

A beam of light L1 indicated by a solid line shows a beam of light when the driver 30 is in a focal position to be in focus (a situation in FIG. 3(b)). A beam of light L2 indicated by an alternate long and short dash line shows a beam of light when the driver 30 is in a position farther from the monocular camera 11 than the focal position to be in focus (a situation in FIG. 3(a)). A beam of light L3 indicated by a broken line shows a beam of light when the driver 30 is in a position closer to the monocular camera 11 than the focal position to be in focus (a situation in FIG. 3(c)).

The above equation shows that the defocus amount d and the distance Z_{blur} when a blur is caused have a correlation. In this embodiment, table information showing a correlation between the defocus amount d of the image of the subject to be picked up by the monocular camera 11 and the distance Z from the monocular camera 11 to the subject is previously prepared and stored in the table information storing part 15b.

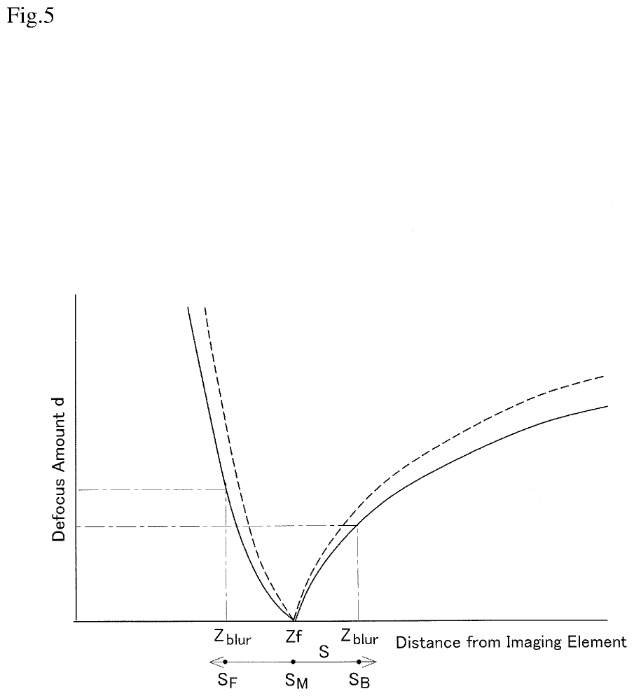

FIG. 5 is a graph showing an example of table information showing the correlation between the defocus amount d and the distance Z stored in the table information storing part 15b.

At the distance Zf of the focal position to be in focus, the defocus amount d is approximately zero. As the distance Z to the driver 30 becomes more distant from the distance Zf of the focal position to be in focus (moves toward the distance Z_{blur}), the defocus amount d increases. The focal distance and aperture of the lens system 11a are set in such a manner that it is possible to detect the defocus amount d within the adjustable range S of the driver's seat 31. As shown by a broken line in FIG. 5, by setting the focal distance of the lens system 11a of the monocular camera 11 to be larger, or by setting the aperture to be wider (the f-number to be smaller), it becomes possible to increase the amount of change in the defocus amount from the focal position.

The distance estimating section 25, with use of the defocus amount d detected by the defocus amount detecting section 24, estimates the distance Z from the head of the driver 30 sitting in the driver's seat 31 to the monocular camera 11 (information about the depth). That is, by fitting the defocus amount d detected by the defocus amount detecting section 24 to the table information stored in the above table information storing part 15b, the distance Z from the head of the driver 30 sitting in the driver's seat 31 to the monocular camera 11 is estimated. In the defocus amount detecting section 24, the defocus amount d of the feature points of the face organs detected by the head detecting section 23, for example, the feature points having clear contrast such as the ends of eyes, the ends of a mouth, and the edges of nostrils, is detected, and by using said defocus amount d in the estimation processing in the distance estimating section 25, the distance estimation becomes easier and the precision of the distance estimation can be improved.

When it is difficult to decide in which direction, forward or backward, the driver 30 is away from the focal position to be in focus (the position of distance Zf) on the basis of the defocus amount d, the sizes of the face area of the driver in a plurality of time-series images are detected. By detecting changes in size of the face area (when the size became larger, the driver is closer to the monocular camera 11, while when the size became smaller, the driver is more distant from the monocular camera 11), it is possible to decide in which direction the driver is away from the focal position. Instead of the table information, with use of an equation showing the correlation between the defocus amount d and the distance Z, the distance Z may be obtained based on the defocus amount d.

The driving operation possibility deciding section 26, with use of the distance Z estimated by the distance estimating section 25, decides whether the driver 30 is in a state of being able to perform a driving operation. For example, it reads a range in which the driver 30 can reach the steering wheel stored in the ROM 13 or the storage section 15 into the RAM 14 and performs a comparison operation so as to decide whether the driver 30 is within the range of reaching the steering wheel 32. A signal indicating said decision result is output to the HMI 40 and the automatic vehicle operation control device 50. The above decision may be made after subtracting the distance B (the distance from the steering wheel 32 to the monocular camera 11) from the distance Z so as to obtain the distance A (the distance from the steering wheel 32 to the driver 30).

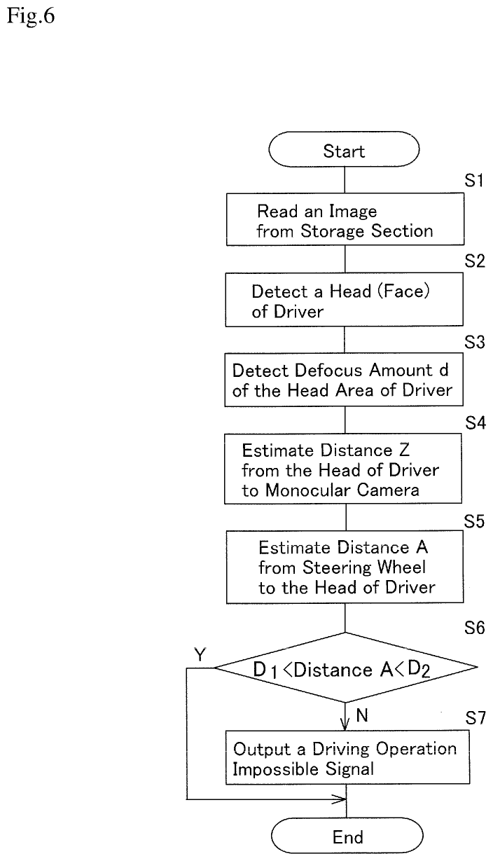

FIG. 6 is a flowchart showing processing operations which the CPU 12 performs in the driver state estimation device 10 according to the embodiment. The monocular camera 11 picks up, for example, 30-60 frames of image per second, and this processing is conducted on every frame or frames at regular intervals.

In step S1, data of one or more images picked up by the monocular camera 11 is read from the image storing part 15a, and in step S2, in the read-out one or more images 11c, the head (face) area of the driver 30A is detected.

In step S3, the defocus amount d of the head of the driver 30A in the image 11c, for example, the defocus amount d of each pixel of the head area, or the defocus amount d of each pixel of the edge area of the head is detected. In order to detect the defocus amount d, the above-mentioned techniques may be adopted.

In step S4, with use of the defocus amount d of the head of the driver 30A in the image 11c, the distance Z from the head of the driver 30 to the monocular camera 11 is estimated. That is, by comparing the above table information read from the table information storing part 15b with the detected defocus amount d, the distance Z from the monocular camera 11 corresponding to the defocus amount d is determined. When estimating the distance Z, changes in size of the face area of the driver in a plurality of images (time-series images) picked up by the monocular camera 11 may be detected so as to decide in which direction, forward or backward, the driver is away from the focal position where the monocular camera 11 focuses, and with use of said decision result and the defocus amount d, the distance Z may be estimated.

In step S5, with use of the distance Z, the distance A from the steering wheel 32 to the head of the driver 30 is estimated. For example, when the steering wheel 32 is on the line segment between the monocular camera 11 and the driver 30, the distance A is estimated by subtracting the distance B between the monocular camera 11 and the steering wheel 32 from the distance Z.

In step S6, by reading out a range wherein the driver can reach the steering wheel stored in the RAM 13 or the storage section 15 so as to conduct a comparison operation, whether the distance A is within the range wherein the steering wheel can be appropriately operated (distance D₁<distance A<distance D₂) is decided. The distance range from the distance D₁ to the distance D₂ is a distance range wherein it is estimated that the driver 30 can operate the steering wheel 32 in a state of sitting in the driver's seat 31, and for example, the distances D₁ and D₂ can be set to be about 40 cm and 80 cm, respectively.

In step S6, when it is judged that the distance A is within the range wherein the steering wheel can be appropriately operated, the processing is ended. On the other hand, when it is judged that the distance A is not within the range wherein the steering wheel can be appropriately operated, the operation goes to step S7.

In step S7, a driving operation impossible signal is output to the HMI 40 and the automatic vehicle operation control device 50, and thereafter, the processing is ended. The HMI 40, when the driving operation impossible signal is input thereto, for example, performs a display giving an alarm about the driving attitude or seat position on the display section 41, and an announcement giving an alarm about the driving attitude or seat position by the voice output section 42. The automatic vehicle operation control device 50, when the driving operation impossible signal is input thereto, for example, performs speed reduction control.

Here, instead of the above processing in steps S5 and S6, by reading out the range wherein the steering wheel can be appropriately operated stored in the RAM 13 or the storage section 15 so as to perform a comparison operation, whether the distance Z is within the range wherein it is estimated that the steering wheel can be appropriately operated (distance E₁<distance Z<distance E₂) may be decided.

In this case, the distances E₁ and E₂ may be, for example, set to be values obtained by adding the distance B from the steering wheel 32 to the monocular camera 11 to the above distances D₁ and D₂. The distance range from the distance E₁ to the distance E₂ is a distance range wherein it is estimated that the driver 30 can operate the steering wheel 32 in a state of sitting in the driver's seat 31, and for example, the distances E₁ and E₂ can be set to be about (40+distance B) cm and (80+distance B) cm, respectively.

Instead of the above steps S4, S5 and S6, based on whether the defocus amount d detected by the defocus amount detecting section 24 is within a prescribed range of defocus amount (defocus amount d₁<defocus amount d<defocus amount d₂), whether the driver is in a position of being able to conduct a driving operation may be judged.

In this case, table information previously prepared about the defocus amounts when the above distance Z or distance A is within the range wherein it is estimated that the steering wheel can be operated (from the above distance E₁ to distance E₂, or from the above distance D₁ to distance D₂) (including the defocus amount d₁ at the distance E₁ or D₁, and the defocus amount d₂ at the distance E₂ or D₂) may be previously stored in the table information storing part 15b, and by reading out the table information about the defocus amount in the above decision so as to conduct a comparison operation, the decision may be made.

Using the driver state estimation device 10 according to the embodiment, with use of the images of different blur conditions of the head of the driver 30 picked up by the monocular camera 11, the head of the driver 30A in the image 11c is detected, the defocus amount of said detected head of the driver 30A in the image 11c is detected, and with use of said defocus amount, the distance Z from the head of the driver 30 sitting in the driver's seat 31 to the monocular camera 11 is estimated. Therefore, without obtaining a center position of the face area in the image 11c, the distance Z can be estimated based on the defocus amount d of the head of the driver 30A in the image 11c, and with use of said estimated distance Z, the state such as a position and attitude of the driver 30 sitting in the driver's seat 31 can be estimated.

Using the driver state estimation device 10, without mounting another sensor in addition to the monocular camera 11, the above-described distance Z or distance A to the driver can be estimated, leading to a simplification of the device construction. And because of no need to mount the another sensor as mentioned above, additional operations accompanying the mounting thereof are not necessary, leading to a reduction of loads applied to the CPU 12, minimization of the device, and cost reduction.

In the table information storing part 15b, the table information showing the correspondence of the defocus amount of the image of the driver (subject) to be picked up by the monocular camera 11 and the distance from the driver (subject) to the monocular camera 11 is stored, and the defocus amount d detected by the defocus amount detecting section 24 and the table information read from the table information storing part 15b are compared so as to estimate the distance Z from the head of the driver 30 sitting in the driver's seat 31 to the monocular camera 11. By fitting the defocus amount d to the table information, the distance Z from the head of the driver 30 sitting in the driver's seat 31 to the monocular camera 11 can be speedily estimated without applying a load to operations.

With use of the distance Z estimated by the distance estimating section 25, the distance A from the steering wheel 32 to the driver 30 is estimated so as to make it possible to decide whether the driver 30 sitting in the driver's seat 31 is in a state of being able to operate the steering wheel, resulting in appropriate monitoring of the driver 30.

By mounting the driver state estimation device 10 on the automatic vehicle operation system 1, it becomes possible to allow the driver to appropriately monitor the automatic vehicle operation. Even if a situation in which cruising control by automatic vehicle operation is hard to conduct occurs, switching to manual vehicle operation can be swiftly and safely conducted, resulting in enhancement of safety of the automatic vehicle operation system 1.

(Addition 1)

A driver state estimation device for estimating a state of a driver using a picked-up image, comprising:

an imaging section which can pick up an image of a driver sitting in a driver's seat;

at least one storage section; and

at least one hardware processor,

the at least one storage section comprising

an image storing part for storing the image picked up by the imaging section, and

the at least one hardware processor comprising

a storage instructing section for allowing the image storing part to store the image picked up by the imaging section,

a reading instructing section for reading the image in which the driver is imaged from the image storing part,

a head detecting section for detecting a head of the driver in the image read from the image storing part,

a defocus amount detecting section for detecting a defocus amount of the head of the driver in the image detected by the head detecting section, and

a distance estimating section for estimating a distance from the head of the driver sitting in the driver's seat to the imaging section with use of the defocus amount detected by the defocus amount detecting section.

(Addition 2)

A driver state estimation method for, by using a device comprising

an imaging section which can pick up an image of a driver sitting in a driver's seat,

at least one storage section, and

at least one hardware processor,

estimating a state of the driver sitting in the driver's seat,

the at least one hardware processor conducting the steps comprising:

storage instructing for allowing an image storing part included in the at least one storage section to store the image picked up by the imaging section;

reading instructing for reading the image in which the driver is imaged from the image storing part;

detecting a head of the driver in the image read from the image storing part,

detecting a defocus amount of the head of the driver in the image detected in the step of detecting the head; and

estimating a distance from the head of the driver sitting in the driver's seat to the imaging section with use of the defocus amount detected in the step of detecting the defocus amount.

### INDUSTRIAL APPLICABILITY

The present invention may be widely applied to an automatic vehicle operation system in which a state of a driver need be monitored, and the like, chiefly in the field of automobile industry.

### DESCRIPTION OF REFERENCE SIGNS

1: Automatic vehicle operation system

10: Driver state estimation device

11: Monocular camera

11a: Lens system

11b: Imaging element

11c: Image

12: CPU

13: ROM

14: RAM

15: Storage section

15a: Image storing part

15b: Table information storing part

16: I/F

17: Communication bus

21: Storage instructing section

22: Reading instructing section

23: Head detecting section

24: Defocus amount detecting section

25: Distance estimating section

26: Driving operation possibility deciding section

30, 30A: Driver

31: Driver's seat

32: Steering wheel

40: HMI

50: Automatic vehicle operation control device

60: Communication bus

1. A driver state estimation device for estimating a state of a driver using a picked-up image, comprising:
an imaging section which can pick up an image of a driver sitting in a driver's seat; and
at least one hardware processor,
the at least one hardware processor comprising
a head detecting section for detecting a head of the driver in the image picked up by the imaging section,
a defocus amount detecting section for detecting a defocus amount of the head of the driver in the image detected by the head detecting section, and
a distance estimating section for estimating a distance from the head of the driver sitting in the driver's seat to the imaging section with use of the defocus amount detected by the defocus amount detecting section, wherein
the distance estimating section estimates the distance from the head of the driver sitting in the driver's seat to the imaging section in consideration of changes in size of a face area of the driver detected in a plurality of images picked up by the imaging section.

2. The driver state estimation device according to claim 1, comprising:
a table information storing part for storing table information showing a correlation between the distance from the head of the driver sitting in the driver's seat to the imaging section and the defocus amount of the image of the driver to be picked up by the imaging section, wherein
the distance estimating section compares the defocus amount detected by the defocus amount detecting section with the table information read from the table information storing part so as to estimate the distance from the head of the driver sitting in the driver's seat to the imaging section.

3. (canceled)

4. The driver state estimation device according to claim 1, wherein
the at least one hardware processor comprises
a driving operation possibility deciding section for deciding whether the driver sitting in the driver's seat is in a state of being able to conduct a driving operation with use of the distance estimated by the distance estimating section.

5. The driver state estimation device according to claim 1, wherein
the imaging section can pick up images of different blur conditions of the head of the driver according to changes in position and attitude of the driver sitting in the driver's seat.

6. A driver state estimation method for, by using a device comprising
an imaging section which can pick up an image of a driver sitting in a driver's seat, and
at least one hardware processor,
estimating a state of the driver sitting in the driver's seat,
the at least one hardware processor conducting the steps comprising:
detecting a head of the driver in the image picked up by the imaging section;
detecting a defocus amount of the head of the driver in the image detected in the step of detecting the head; and
estimating a distance from the head of the driver sitting in the driver's seat to the imaging section with use of the defocus amount detected in the step of detecting the defocus amount,
the step of estimating the distance, wherein the distance from the head of the driver sitting in the driver's seat to the imaging section is estimated in consideration of changes in size of a face area of the driver detected in a plurality of images picked up by the imaging section.

7. The driver state estimation device according to claim 2, wherein
the at least one hardware processor comprises
a driving operation possibility deciding section for deciding whether the driver sitting in the driver's seat is in a state of being able to conduct a driving operation with use of the distance estimated by the distance estimating section.

8. The driver state estimation device according to claim 2, wherein
the imaging section can pick up images of different blur conditions of the head of the driver according to changes in position and attitude of the driver sitting in the driver's seat.

9. The driver state estimation device according to claim 4, wherein
the imaging section can pick up images of different blur conditions of the head of the driver according to changes in position and attitude of the driver sitting in the driver's seat.

10. The driver state estimation device according to claim 7, wherein
the imaging section can pick up images of different blur conditions of the head of the driver according to changes in position and attitude of the driver sitting in the driver's seat.
